(19) United States
(12) Patent Application Publication
(10) Pub. No.: US 2004/0006578 A1
(43) Pub. Date: Jan. 8, 2004

(54) System and method for distributed concurrent version management

(76) Inventors: Trsunyeng Yu, Shindian City (TW); Hubert Chiu, Shindian City (TW); Eric Yeh, Shindian City (TW)

Correspondence Address: RABIN & BERDO, P.C., SUITE 500, 1101 14TH STREET, N.W., WASHINGTON, DC, 20005, US

(21) Appl. No.: 10/305,031

(22) Filed: Nov. 27, 2002

(30) Foreign Application Priority Data
Jul. 8, 2002 (TW) 91115055

(51) Int. Cl. G06F 17/30; G06F 12/00

(52) U.S. Cl. 707/201

(57) ABSTRACT

A system for distributed concurrent version management. The system includes a first server, a second server, and a first client. The first server has a first database including a file. The second server has a second database including a file copy corresponding to the file, a data replication module, and a connection detection module. When the first client wants to replace the file copy in the second server with an updated file, the file copy is replaced by the updated file when the first server and the second server are connected. Then, the updated file is copied to the first server by the data replication module, and the file in the first database is replaced by the updated file.

### BACKGROUND OF THE INVENTION

1. Field of the Invention

The present invention relates to a file management system and method, and particularly to a system and method for distributed concurrent version management that maintains the consistency of file copies on different servers, so as to reduce the connection cost when accessing a single server.

2. Description of the Related Art

In conventional file management and concurrent version systems such as a source code management system, all source codes are stored into a single server that can provide functions to manage the source codes. Clients may connect to the server to access the source codes through networks to update or modify the codes. The server can maintain the validity of the source codes by employing appropriate authorization management.

FIG. 1 is a schematic diagram illustrating a conventional file management system. As shown in FIG. 1, all files are stored in the database 101 of the server 100. To access files on the server 100, users may employ client 110 (120) to connect to the server 100 and access files in the database 101 through networks. The client 110 (120) and server 100 are constructed as a client-server-based system by employing a concurrent version management system, such as the VSS (Visual SourceSafe), thus the server 100 has the ability to manage the database 101 with authorization.

Since all clients must connect to the same server to access files, the system load is rapidly raised if a large number of clients connect to the server at the same time. Further, the cost of constructing networks or dedicated lines is expensive for enterprises with branches in different countries.

### SUMMARY OF THE INVENTION

It is therefore an object of the present invention to provide a system and method for distributed concurrent version management that maintains the consistency of file copies on different servers, so as to reduce the connection cost when accessing a single server.

To achieve the above objects, the present invention provides a system and method for distributed concurrent version management. According to one embodiment of the invention, the system includes a first server, a second server, and a client B (first client).

The first server has a first database including a file. The second server has a second database including a file copy corresponding to the file in the first database, a data replication module, and a connection detection module. The connection detection module detects the connection status between the first server and the second server. When the client B wants to replace the file copy in the second server with an updated file, the file copy is replaced by the updated file if the connection status is connected. Then, the file copy in the second database is replaced by the updated file, and the updated file in the second database is copied to the first server by the data replication module to replace the file and the file in the first database is replaced by the updated file.

Further, the system time is adjusted between the second server and the client B when replacing the file copy in the second server with an updated file when connected, and a time tag according to the updated system time is labeled after the file copy is replaced by the updated file.

The time tag corresponding to the updated file is further compared to a new time tag corresponding to the file in the first server before the file is replaced by the updated file. The file is replaced by the updated file if the time tag is later than the new time tag, that is, if the time tag is generated later than the new time tag. Otherwise, the file is not replaced by the updated file.

In addition, a client A (second client) cannot update the file in the first server while the file copy is being updated by the client B. When disconnection status is detected, the client B can update the file copy in the second server, but the client A cannot update the file in the first server.

According to another embodiment of the invention, a method for distributed concurrent version management is provided. The method is suitable for use in a system with a first server having a file, a second server having a file copy corresponding to the file, and a client B.

First, the connection status between the first server and the second server is detected. When the client B wants to replace the file copy in the second server with an updated file, the file copy is replaced by the updated file when the connection status is connected. Then, the updated file is copied to the first server and the file is replaced by the updated file.

Further, system time is adjusted between the second server and the client B if the client B wants to replace the file copy in a second server with an updated file when connected and a time tag according to the updated system time is labeled after the file copy is replaced by the updated file.

The time tag corresponding to the updated file is further compared to a new time tag corresponding to the file in the first server before the file is replaced by the updated file. The file is replaced by the updated file if the time tag is later than the new time tag. Otherwise, the file is not replaced by the updated file.

Similarly, a client A cannot update the file in the first server when the file copy is updated by the client B. When the first server and second server are disconnected, the client B can update the file copy in the second server, but the client A cannot update the file in the first server.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram illustrating the conventional file management system;

FIG. 2 is a schematic diagram showing the architecture of the system for distributed concurrent version management according to the embodiment of the present invention; and

FIG. 3 is a flowchart illustrating the operation of the method for distributed concurrent version management according to the embodiment of the present invention.

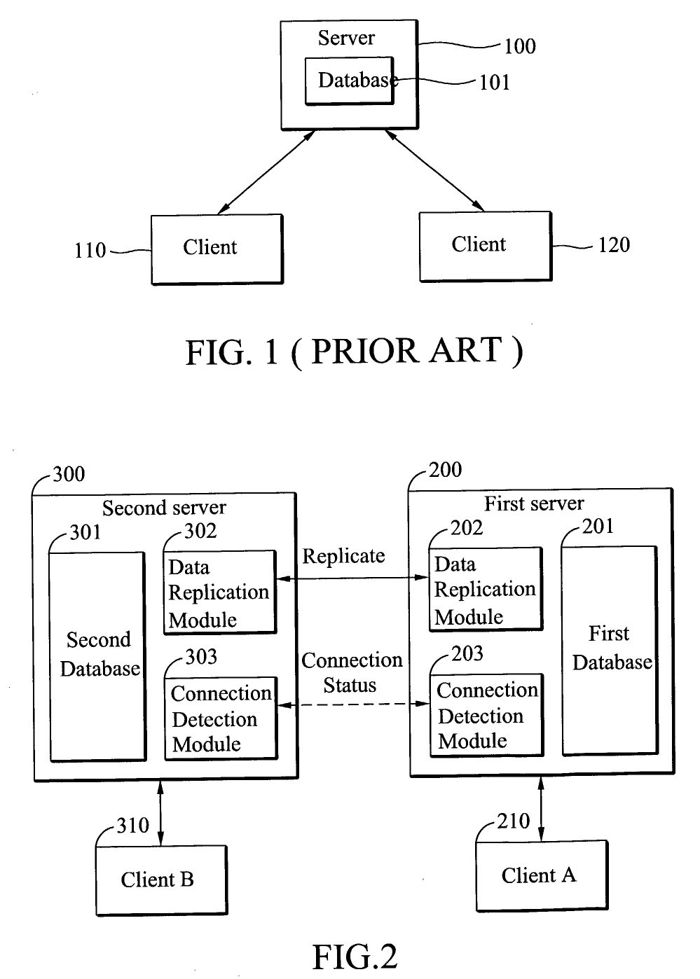

### DETAILED DESCRIPTION OF THE INVENTION

FIG. 2 is a schematic diagram showing the architecture of the system for distributed concurrent version management according to the embodiment of the present invention.

According to the embodiment of the invention, the system for distributed concurrent version management includes a first server 200, a client A (second client) 210, a second server 300, and a client B (first client) 310.

The first server 200 and the second server 300 have the same components. The first server 200 has a first database 201 including a file (not shown in FIG. 2), a data replication module 202, and a connection detection module 203. The data replication module 202 monitors the status of the first database 201. When the data in the first database 201 is updated, the data replication module 202 copies the updated data to another server. The connection detection module 203 detects the connection status between the first server 200 and the second server 300.

Similarly, the second server 300 has a second database 301, a data replication module 302, and a connection detection module 303. The second database 301 includes a file copy (not shown in FIG. 2) corresponding to the file in the first database 201 of the first server 200. The file copy is the same as the file, and the file and the file copy may be source codes.

The data replication module 302 monitors the status of the second database 301. When the data in the second database 301 is updated, the data replication module 302 copies the updated data to another server. The connection detection module 303 detects the connection status between the second server 300 and the first server 200.

The first server 200 provides services, such as file access, to the client A 210, and the second server 300 provides services to the client B 310. It should be noted that the server requested by the client can be determined according to the distance. For example, the client B 310 in one country may connect to the second server 300 and the client A 210 in another country may connect to the first server 200 if the first server 200 is in the second country and the second server 300 is in the first.

When the client B 310 wants to replace the file copy in second database 301 of the second server 300 with an updated file (not shown in FIG. 2), the connection status is detected by the connection detection module 303. If the second server 300 and the first server 200 are connected, the system time is adjusted between the second server 300 and the client B 310. That is, the time of the client B 310 is set as the system time of the second server 300.

Then, the file copy in second database 301 of the second server 300 is replaced by the updated file, and a time tag according to the updated system time is labeled after the file copy is replaced by the updated file.

Once the data replication module 302 monitors the update of the second database 301, the time tag corresponding to the updated file is compared to a time tag (new time tag) corresponding to the file in the first server 200.

The updated file is copied to the first server 200 by the data replication module 302 and the file is replaced by the updated file if the time tag is later than the new time tag, that is, if the time tag is generated later than the new time tag. Otherwise, the updated file is not copied to the first server 200 and the file in the first server 200 is not replaced by the updated file.

It should be noted that the purpose of adjusting the system time at the beginning of replication is to make sure that the client B 310 uses the same system time as the second server 300 in replication. To compare the time tags is to make sure that the latest updated file is kept in the database so as to maintain the accuracy of the database.

Since the first server 200 and the second server 300 have the same components, and that the relation between the client A 210 and the first server 200 and the relation between the client B 310 and the second server 300 are the same, when successful connection between the second server 300 and the first server 200 are detected by the connection detection module 203, the components in first server 200 work in the same manner as those in second server 300, but the roles of the first and second server 200 and 300 are interchanged.

In addition, the client A 210 cannot update a specific file in the first server 200 when the copy of the specific file in the second server 300 is being updated by the client B 310. Similarly, the client B 310 cannot update the file copy in the second server 300 when the file in the first server 200 is being updated by the client A 210.

The client B 310 can update the file copy in the second server 300 if disconnection is detected between the first server 200 and the second server 300. The client A 210, however, cannot update the file in the first server 200 if the first server 200 and the second server 300 are disconnected. In this case, the second server 300 is designated as master server and the first server 200 is the secondary server. For consistence of database file versions, the master server may provide full functions to clients if the master and secondary servers are disconnected, but the secondary server provides only limited functions, such as reading without updating.

It should be noted that the clients and the servers (the client A 210 and first server 200, and the client B 310 and second server 300) may be constructed as client-server-based systems by employing a concurrent version management system, such as the VSS (Visual SourceSafe), thus the servers (200 and 300) can manage the database (201 and 301) with suitable authorization. As described above, the second server 300 and the first server 200 can be constructed as the master server and the secondary server respectively by employing the concurrent version management system, VSS. Further, the data replication modules (202 and 302) may be constructed according to Microsoft's File Replication Service (FRS).

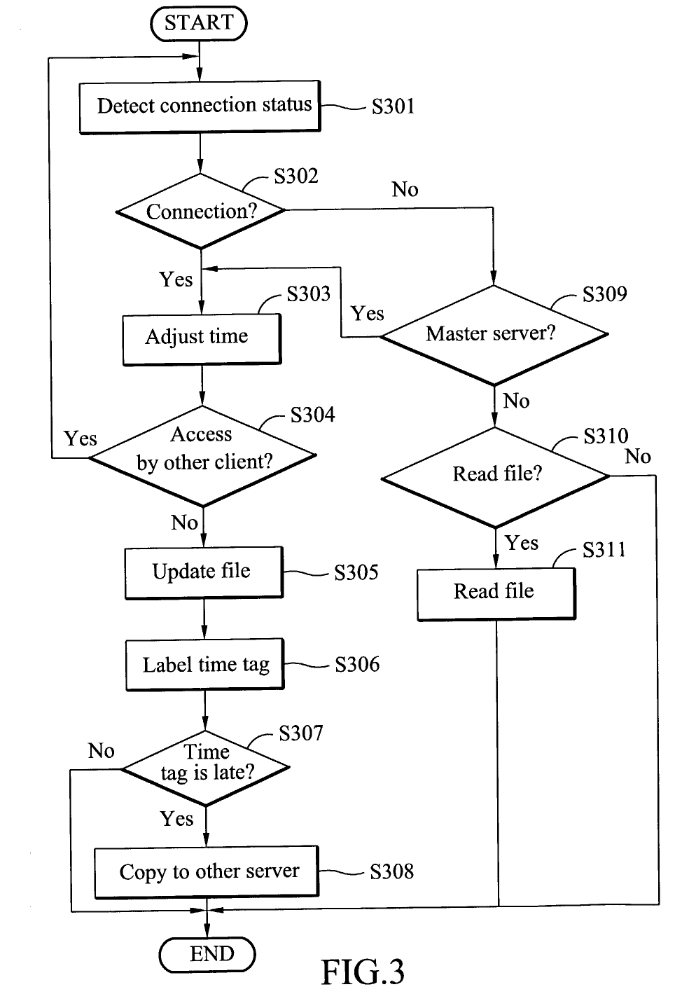

FIG. 3 is a flowchart illustrating the operation of the method for distributed concurrent version management according to the embodiment of the present invention.

The method for distributed concurrent version management is suitable for use in a system with a first server having a file, a second server having a file copy corresponding to the file, and at least one client.

When the client wants to replace the file copy in the second server with an updated file, in Step S301, the connection status between the first server and the second server is detected. If the second server and the first server are connected (Yes in Step S302), the system time is adjusted between the second server and the client. That is, the time of the client is set as the system time of the second server.

Then, in Step S304, it is determined whether the file copy is accessed by other clients. The procedure returns to Step S301 if so, otherwise, in Step S305, the file copy on the second server is replaced by the updated file, and in Step S306, a time tag according to the updated system time is labeled after the file copy is replaced by the updated file.

Thereafter, in Step S307, the time tag corresponding to the updated file is compared to the time tag (new time tag) corresponding to the file in the first server. Then, in Step S308, the updated file is copied to the first server and the file is replaced by the updated file if the time tag is later than the new time tag (Yes in Step S307). Otherwise, the updated file is not copied to the first server and the file in the first server is not replaced by the updated file.

Further, in Step S309, it is determined whether the server connected by the client is the master server when the second server and the first server are disconnected (No in Step S302). If the server is the master server (Yes in Step S309), the procedure returns to Step S303; otherwise, goes to Step S311. In Step S311, if the client simple wants to read the file, the file is read (downloaded) by the client as the client wants (Yes in Step S310).

For consistence of database file versions, when the master and secondary server are disconnected, the master server may provide full functions to clients but the secondary server only provides limited functions, such as reading without updating.

It should be noted that the embodiment of present invention manages concurrent versions, that is, situations in which there are several versions of a file. The data type of a file in the concurrent file versions management system includes version information, while the data type of a file in the concurrent file management system does not contain such version information. Similarly, the present invention may be applied to the management of concurrent files and concurrent file versions.

As a result, using the system and method for distributed concurrent version management according to the present invention, the consistency of file copies on different servers can be maintained, so as to reduce connection costs when accessing a single server.

Although the present invention has been described in its preferred embodiment, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system for distributed concurrent version management, comprising:
a first server having a first database including a file;
a second server having a second database including a file copy corresponding to the file in the first database, a data replication module, and a connection detection module to detect the connection status between the first server and the second server; and
a first client to replace the file copy in the second server with an updated file when the connection status is connected;
wherein the updated file is copied to the first server by the data replication module in the second server and the file in the first database is replaced by the updated file.

2. The system as claimed in claim 1 wherein system time is adjusted between the second server and the first client before the first client replaces the file copy in the second server with the updated file.

3. The system as claimed in claim 2 wherein a time tag according to the adjusted system time is assigned after the file copy is replaced by the updated file.

4. The system as claimed in claim 3 wherein the time tag corresponding to the updated file is compared to a new time tag corresponding to the file in the first server before the file is replaced by the updated file, and the file is replaced by the updated file if the time tag is later than the new time tag.

5. The system as claimed in claim 1 wherein the first client can update the file copy in the second server, but a second client cannot update the file in the first server if a disconnection status between the first and the second server is detected.

6. The system as claimed in claim 1 wherein the file is a source code file.

7. The system as claimed in claim 1 wherein the file is a file with a version data type.

8. The system as claimed in claim 7 wherein system time is adjusted between the second server and the first client before the first client replaces the file copy in the second server with the updated file.

9. The system as claimed in claim 8 wherein the file is not replaced by the updated file if a time tag labeled after the file copy is replaced by the updated file is earlier than a new time tag corresponding to the file in the first server.

10. The system as claimed in claim 7 wherein a second client cannot update the file in the first server while the file copy is being updated by the first client.

11. The system as claimed in claim 7 wherein the first client can update the file copy in the second server, but a second client cannot update the file in the first server if a disconnection status between the first and the second server is detected.

12. The system as claimed in claim 7 wherein the file is a source code file.

13. A method for distributed concurrent version management for use in a system with a first server having a file, a second server having a copy corresponding to the file and a first client, comprising the steps of:
detecting the connection status between the first server and the second server;
replacing the file copy with an updated file from the first client when the connection status is connected; and
copying the updated file to the first server by the second server and replacing the file with the updated file.

14. The method as claimed in claim 13 further adjusting system time between the second server and the first client before the file copy in the second server is replaced by the updated file.

15. The method as claimed in claim 14 further comparing a time tag labeled after the file copy is replaced by the updated file with a new time tag corresponding to the file in the first server before the file is replaced by the updated file, and replacing the file with the updated file if the time tag is later than the new time tag.

16. The method as claimed in claim 13 wherein the first client can update the file copy in the second server, but a second client cannot update the file in the first server if a disconnection status between the first and the second server is detected.

17. The method as claimed in claim 13 wherein the file is a source code file.

18. The method as claimed in claim 13 wherein the file is a file with version data.

19. The method as claimed in claim 18 further adjusting system time between the second server and the first client before the file copy in the second server is replaced by the updated file.

20. The method as claimed in claim 18 wherein the first client can update the file copy in the second server, but a second client cannot update the file in the first server if a disconnection status between the first and the second server is detected.
